(19) United States
(12) Patent Application Publication
(10) Pub. No.: US 2012/0018505 A1
(43) Pub. Date: Jan. 26, 2012

(54) Tag having dipole-loop antenna

(75) Inventors: Bing Jiang, San Diego, CA (US); Richard John Campero, San Clemente, CA (US); Steven E. Trivelpiece, Irvine, CA (US)

(73) Assignee: Sensormatic Electronics , LLC, Boca Raton, FL (US)

(21) Appl. No.: 12/804,543

(22) Filed: Jul. 23, 2010

(51) Int. Cl. G06K 19/077; G06F 17/00

(52) U.S. Cl. 235/375; 235/492

(57) ABSTRACT

A tag has a dipole and loop antenna.

The present disclosure relates generally to tags having a dipole-loop antenna useful in applications with limited space, such as for use on commercial articles.

### BACKGROUND

A radio-frequency identification (RFID) system may be used for a number of applications, such as managing inventory, electronic access control, security systems, automatic identification of cars on toll roads, electronic article surveillance (EAS), and so forth. A RFID system may comprise a RFID reader and a RFID device. The RFID reader may transmit a radio-frequency carrier signal to the RFID device, such as a RFID inlay or RFID tag. The RFID device may respond to the carrier signal with a data signal encoded with information stored by the RFID device. A RFID device typically includes an antenna to communicate signals between the RFID device and the RFID reader. The antenna should be tuned to operate within a predetermined operating frequency band.

### SUMMARY OF THE PRESENT INVENTION

The invention includes a tag having a substrate with a surface, a non-linear device mounted on the surface and an antenna connected to the non-linear device. The antenna comprises a first antenna portion, a second antenna portion and a third antenna portion, with the first, second and third antenna portions connected to the non-linear device. Each of the first and second antenna portions comprise a one-half (½) dipole structure. The third antenna portion comprises a loop configuration. A fourth antenna portion provides a shorted connection to one of the other three antenna portions. The antenna is tuned to an operating frequency band by modifying the electrical length for one, two, or all three antenna portions. Preferably, the invention also includes a slot inductive portion that includes a piece of conductor with a thin slot trace. This slot inductive portion is used for the impedance matching for the non-linear device. The impedance matching is provided by modifying the length or width of the slot.

The invention also includes a security system having a reader and the above-identified tag.

Additionally, the invention includes a method for monitoring the status of commercial articles, which includes the steps of placing the above-identified security system into a commercial location, associating the tag to a commercial article, and monitoring the location of the commercial article through the tag with the reader during transit of the commercial article.

### BRIEF DESCRIPTION OF THE DRAWINGS

FIG. 1 illustrates a security system of the invention;

FIG. 2 illustrates an expended side view of a tag of the invention;

FIG. 3 illustrates a comparison between a two dipole antennae system and the dipole-loop antenna of the invention;

FIG. 4 illustrates a top view of an embodiment of a tag antenna of the invention; and,

FIG. 5 is a prophetic graphical representation of the performance difference between a dipole antenna and a theoretical dipole-loop antenna of the invention.

### DETAILED DESCRIPTION OF THE PREFERRED EMBODIMENT

The invention includes an identification and/or security tag having a combination dipole-loop antenna. The tag has a non-linear device mounted on a substrate and an antenna system connected to the non-linear device. The antenna includes three antenna portions, with each antenna portion connected to the non-linear device. Two of the antenna portions include a one-half (½) dipole structure, with the third antenna portion configured into a loop. A fourth antenna portion is implemented as a shorted connection to one of the other three antenna portions. The antenna is tuned to an operating frequency band by modifying the electrical length for one or both of the ½ dipole antenna portions, and/or the loop antenna portions. A slot inductive portion is preferably used for the impedance matching for the non-linear device. The impedance matching is provided by modifying the slot length or width.

A RFID device may have a non-linear device with the two half dipole antenna portions and a loop antenna portion. The antenna may be tuned to a desired operating frequency band by adjusting its parameters such as the length of the antenna portions. The operating frequencies may vary, although the embodiments may be particularly useful for ultra-high frequency (UHF) spectrum. Preferably, the tag may be tuned to operate within an RFID commercially standardized operating frequency band of from about 865 MHz to about 956 MHz, such as from about 865 MHz to about 868 MHz, which encompasses the 868 MHz band used in Europe, from about 902 MHz to about 928 MHz, which encompasses the 915 MHz Industrial, Scientific and Medical (ISM) band used in the United States, and from about 950 MHz to about 956 MHz, which encompasses the 950 MHz band proposed for Japan, and combinations of these frequency ranges.

The non-linear device may include a semiconductor integrated circuit (IC), diodes, capacitors, inductors, or combination thereof Integrated circuits may include a RF rectifier circuit to convert RF energy to DC energy, logic circuits to decode and encode information, or other like functionalities.

Preferably, the tag includes an adhesive and release liner to attach to an object, or other fixing mechanisms to attach to, or otherwise associate to, a commercial article, with such mechanisms known to those skilled in the art of tags.

A security system of the invention generally includes a reader for identifying the tag. In operation, the security system is used to monitor the status of commercial articles by placing the security system into a commercial location, associating the tags to commercial articles, and monitoring the location of the associated commercial articles through the tag with the reader during transit of the commercial articles within or out of the commercial location.

In one embodiment, for example, the antenna may have unique antenna geometry of an inwardly spiral pattern useful for RFID applications or EAS applications. The inwardly spiral pattern may nest the antenna traces thereby bringing the traces back towards the origin. This may result in an antenna similar in functionality as a conventional dipole antenna, but with a smaller overall size.

Numerous specific details may be set forth herein to provide a thorough understanding of the embodiments. It will be understood by those skilled in the art, however, that the embodiments may be practiced without these specific details. In other instances, well-known methods, procedures, components and circuits have not been described in detail so as not to obscure the embodiments. It can be appreciated that the specific structural and functional details disclosed herein may be representative and do not necessarily limit the scope of the embodiments.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

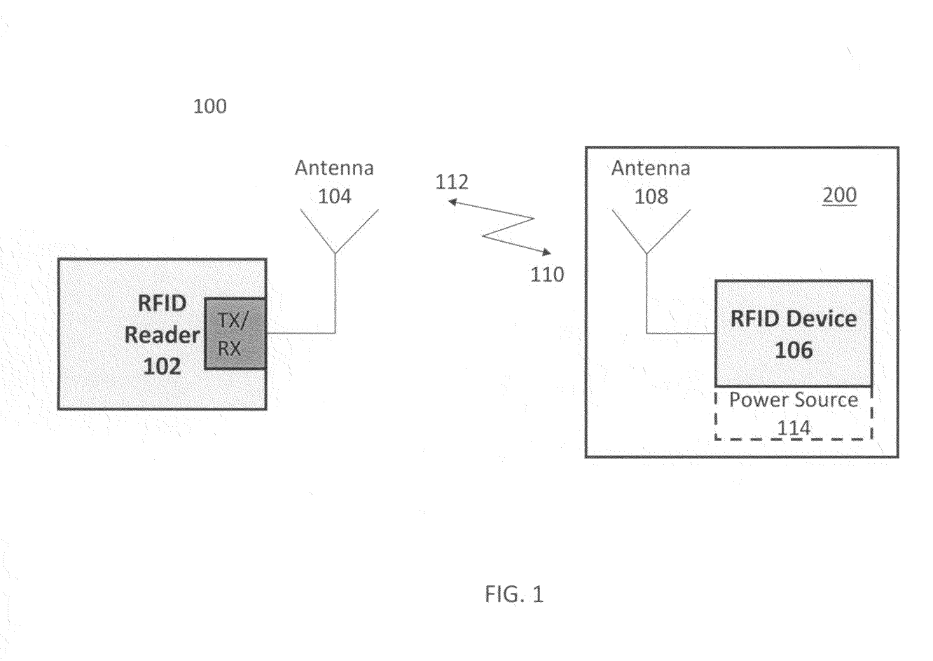

Referring now in detail to the drawings wherein like parts are designated by like reference numerals throughout, there is illustrated in FIG. 1 a RFID system 100. In FIG. 1, the RFID system 100 has an RFID reader 102 with an antenna 104. The RFID reader 102 is in communication 110, 112 with a tag 200 incorporating a RFID device 106 with an antenna 108. The RFID reader 102 uses a transmitter (TX) to transmit a signal 110 through its antenna 104 which is received by the RFID device 106 through its antenna 108. Once the signal 110 is received, the RFID device 106 uses the energy of the signal 110 to generate its own response 112, which is conveyed through the antenna 108 and transmitted 112 back to the antenna 104 through a receiver (RX) of the RFID reader 102. In one embodiment, for example, the RFID system 100 may be configured to operate using the RFID device having an operating frequency in the 868 MHz band, the 915 MHz band, and the 950 MHz band. RFID system 100, however, may also be configured to operate using other portions of the RF spectrum as desired for a given implementation. The embodiments are not limited in this context.

The RFID system 100 may comprise a plurality of nodes. The term “node” as used herein may refer to a system, element, module, component, board or device that may process a signal representing information. The signal may be, for example, an electrical signal, optical signal, acoustical signal, chemical signal, and so forth. The embodiments are not limited in this context.

As shown in FIG. 1, RFID system 100 may comprise a RFID reader 102 and a RFID device 106. Although FIG. 1 shows a limited number of nodes, it can be appreciated that any number of nodes may be used in security system 100. The embodiments are not limited in this context.

In one embodiment, RFID device 106 may comprise a RFID tag. An RFID tag may include memory to store RFID information, and may communicate the stored information in response to an interrogation signal 110 through the antenna 104. RFID information may include any type of information capable of being stored in a memory used by RFID device 106. Examples of RFID information may include a unique tag identifier, a unique system identifier, an identifier for the monitored object, and so forth. The types and amount of RFID information are not limited in this context.

In one embodiment, RFID device 106 may comprise a passive RFID tag. A passive RFID tag does not use an external power source (114), but rather uses interrogation signals 110 from the antenna 104 as a power source. RFID device 106 may be activated by a direct current voltage that is developed as a result of rectifying the incoming RF carrier signal comprising interrogation signals 110. Once RFID device 106 is activated, it may then transmit the information stored in its memory register through response signals 112.

In general passive operation, when antenna 108 of RFID device 106 is in the working distance of the antenna 104 of the RFID reader 102, it develops an AC voltage across antenna 108. The AC voltage across antenna 108 is rectified and when the rectified power becomes sufficient enough to activate RFID device 106, RFID device 106 may start to send stored data in its memory register by modulating interrogation signals 110 of RFID reader 102 to form response signals 112. RFID reader 102 may receive response signals 112 and converts them into detected serial data information from RFID device 106.

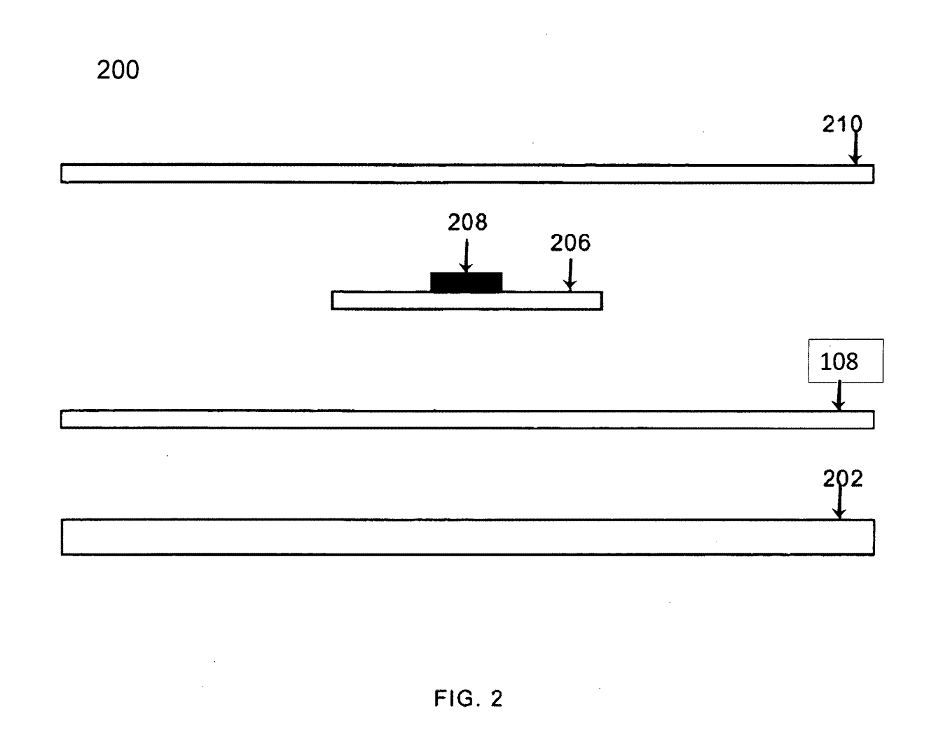

Referring to FIG. 2, a side expended view for a tag 200 is illustrated. As shown in FIG. 2, tag 200 may include a substrate 202, the antenna 108, a lead frame 206, a semiconductor IC 208, and a covering material 210. Although FIG. 2 illustrates a limited number of elements, it may be appreciated that more or less elements may be used for tag 200. For example, an adhesive and release liner may be added to tag 200 to assist in attaching tag 200 to an object to be monitored. The embodiments are not limited in this context.

In one embodiment, tag 200 may include substrate 202. Substrate 202 may comprise any type of material suitable for mounting antenna 108, lead frame 206, and IC 208. For example, material for substrate 202 may include base paper, polyethylene, polyester, and so forth. The particular material implemented for substrate 202 may impact the RF performance of tag 200. More particularly, the dielectric constant and the loss tangent may characterize the dielectric properties of an appropriate substrate material for use as substrate 202. The antenna 108 of the tag 200 is disposed upon substrate 202. Substrate 202 may be substantially irregular in shape in order to be fitted in the host housing, for example, with that housing having limited space. Antenna 108 may be disposed on substrate 202 by die-cutting the label antenna pattern onto substrate 202. Substrate 202 may comprise, for example, paper-back aluminum foil. RFID chip 208 may be connected to lead frame 206 by ultrasonically bonding lead frame 206 to the conductive pads on RFID chip 208. RFID chip 208 and lead frame 206 may be placed directly in the geometric center of the dielectric substrate material of substrate 202. The ends of lead frame 206 may be physically and electrically bonded to the foil antenna pattern of antenna 108.

The term “read range” may refer to the communication operating distance between RFID reader 102 and RFID device 106. An example of a read range for tag 200 may cover up to ten (10) meters, although the embodiments are not limited in this context. The loss tangent may characterize the absorption of RF energy by the dielectric. The absorbed energy may be lost as heat and may be unavailable for use by IC 208. The lost energy may be same as reducing the transmitted power and may reduce the read range accordingly. Consequently, it may be desirable to have the lowest loss tangent possible in substrate 202 since it cannot be “tuned out” by adjusting antenna 108. The total frequency shift and RF loss may depend also on the thickness of substrate 202. As the thickness increases, the shift and loss may also increase.

In one embodiment, for example, substrate 202 may be implemented using base paper. The base paper may have a dielectric constant of 3.3, and a loss tangent of 0.135. The base paper may be relatively lossy at 900 MHz. The embodiments are not limited in this context.

In one embodiment, tag 200 may include IC 208. IC 208 may comprise a semiconductor IC, such as an RFID chip or application specific integrated circuit (ASIC) (“RFID chip”). RFID chip 208 may include, for example, an RF or alternating current (AC) rectifier that converts RF or AC voltage to DC voltage, a modulation circuit that is used to transmit stored data to the RFID reader, a memory circuit that stores information, and a logic circuit that controls overall function of the device. In one embodiment, for example, RFID chip 208 may be implemented using the Monza 3 or Monza 4 RFID ASIC made by Imping of Seattle, Wash. The embodiments, however, are not limited in this context.

In one embodiment, tag 200 may include lead frame 206. A lead frame may be an element of leaded packages, such as Quad Flat Pack (QFP), Small Outline Integrated Circuit (SOIC), Plastic Leaded Chip Carrier (PLCC), and so forth. Lead frame 206 may include a die mounting paddle or flag, and multiple lead fingers. The die paddle primarily serves to mechanically support the die during package manufacture. The lead fingers connect the die to the circuitry external to the package. One end of each lead finger is typically connected to a bond pad on the die by wire bonds or tape automated bonds. The other end of each lead finger is the lead, which is mechanically and electrically connected to a substrate or circuit board. Lead frame 206 may be constructed from sheet metal by stamping or etching, often followed by a finish such as plating, downset and taping. In one embodiment, for example, lead frame 206 may be implemented using a Sensormatic EAS Microlabel lead frame made by Sensormatic Corporation, for example. The embodiments, however, are not limited in this context.

In one embodiment, tag 200 may include covering material 210. Covering material 210 may be cover stock material applied to the top of a finished tag. As with substrate 202, covering material 210 may also impact the RF performance of RFID device 106. Covering material 210 may then be applied over the entire top surface of tag 200 to protect the assembly and provide a surface for printing, if desired. In one embodiment, for example, covering material 210 may be implemented using cover stock material having a dielectric constant of 3.8 and a loss tangent of 0.115. The embodiments are not limited in this context.

The tag 200 includes antenna 108 which comprise a dipole-loop configuration. Antenna 108 may be designed so that the complex conjugate of the overall antenna would match impedance to the complex impedance of lead frame 206 and IC 208 at the desired operating frequency, such as 915 MHz, for example. When RFID device 106 is placed on an object to be monitored, however, the resulting operating frequency may change. Each object may have a substrate material with dielectric properties affecting the RF performance of antenna 108. As with substrate 202, the object substrate may cause frequency shifts and RF losses determined by the dielectric constant, loss tangent, and material thickness. Examples of different object substrates may include chip board which is material used for item-level cartons, corrugated fiber board which is material used for corrugated boxes, video cassette and DVD cases, glass, metal, and so forth. Each object substrate may have a significant affect on the read range for RFID device 106.

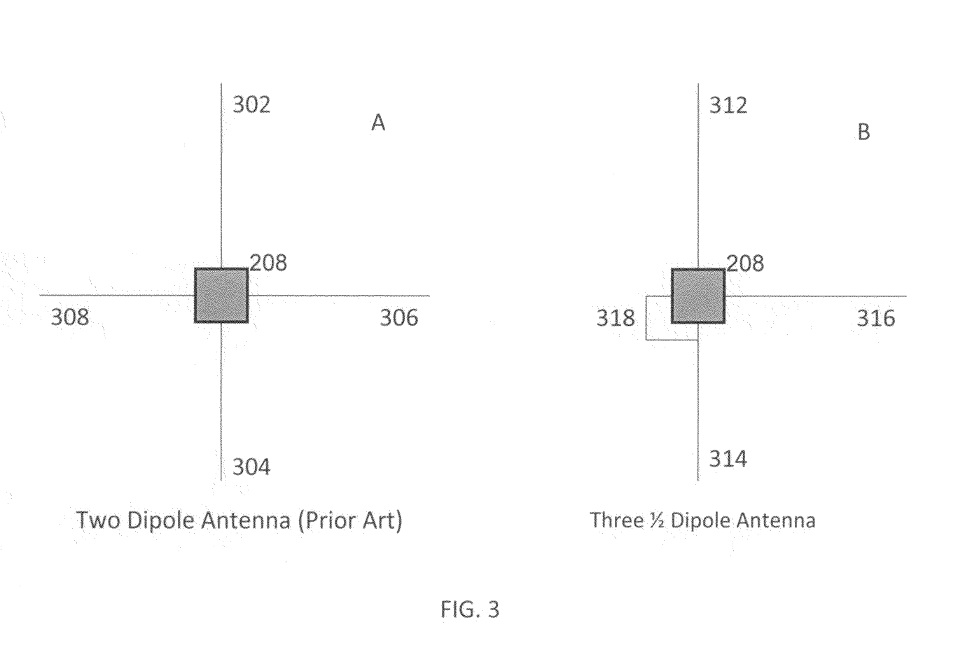

Referring to FIG. 3, two illustrations are shown. The first illustration, labeled “Two Dipole Antenna (Prior Art)”, schematically represents a standard two dipole antennae system 302, 304, 306, 308 attached to a non-linear device. As the radiation directivity of a dipole antenna (such as the pair of 302 and 304) forms a null along its longitude orientation, a second independent dipole antenna (such as the pair of 306 and 308) along the first antenna's orthogonal direction is introduced. However, this configuration may not properly map onto a substrate in certain limited space applications. In the second illustration, labeled “Dipole-Loop Antenna”, a schematic representation of the invention is shown having a first half dipole 312, a second half dipole 314, and a loop 316 with two ends 318 and 320. In alternative embodiments, the antenna loop portion 316 may be connected with the half dipole 312 or 314. The loop antenna portion provides a radiation pattern that is complementary to the dipole 312 and 314. As seen in this comparison between a two dipole antennae system and the dipole-loop antenna of the invention, placement of the antenna in space limited applications is possible with the dipole-loop system while retaining significant performance criteria of the tag 200.

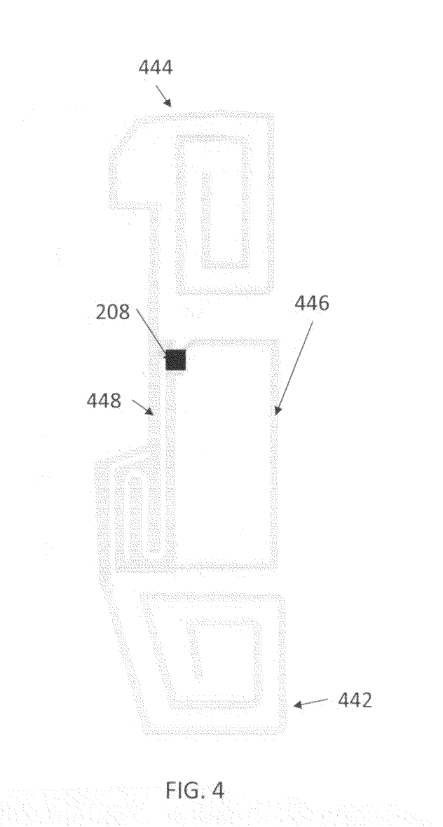

FIG. 4 shows an antenna pattern with two ½ dipoles (442, 444), a loop portion 446 and of a short connection 448 between the loop and the dipole. As seen in FIG. 4, the first half dipole (442) and the second half dipole (444) have unique configurations as the inwardly spiral pattern, which reduces the antenna size while maintaining reasonable functional performance. In this embodiment, for example, the antenna length may be 50.5 mm while maintaining reasonable frequency bandwidth (865 MHz to 960 MHz). In alternative embodiments, the antenna may be reduced further in size with a reduction of bandwidth. As seen in FIG. 4, the first and second ½ dipole portions are with substantially irregular spiral shape in order to be fitted in the host housing. Alternatively, these portions can be in regular shapes, such as squiggle, rectangular, square, circular, etc. The embodiments are not limited in this context. In one embodiment, the first and second directions may form counter-clock wise and clock wise spirals, respectively. The embodiments, however, are not necessarily limited in this context.

The loop portion 446 of the invention, shown in FIG. 4, is a closed rectangular shape. Alternatively, this portion can be in any closed shapes, such as symmetrical and non-symmetrical circles, triangles, squares, pentagons, octagons, etc, and other like configurations for use in the present invention. However, the embodiments are not limited in this context.

Because the IC 208 usually has complex impedance (large negative imaginary impedance), the antenna 108 preferably includes a designed configuration with extra inductance to neutralize the imaginary impedance of IC 208. In one preferred embodiment, a slot inductive portion (448 of FIG. 4) may be used. This slot inductive portion 448 is used for the impedance matching for the non-linear device. The impedance matching is provided by modifying the slot length. The slot inductive portion 448 preferably includes a piece of conductor with a thin slot trace. The slot inductive portion 448 connects the first and second ½ dipole portions together for impedance match of the non-linear device. Additionally, the inductance is tuned to cancel the imaginary impedance of the non-linear device by adjusting the length or width of the slot. A slot inductive portion has conductor covering its major area. Due to the tight distance between the two edges of the slot, the electromagnetic field is well confined along the slot, instead of going further away from the conductor. As an advantage, this type of inductive parts can be put to the proximity of a piece of metal without losing its inductance. By adjusting the slot length or width, the inductance is tuned to cancel the imaginary impedance of the non-linear device. The embodiments, however, are not limited in this context.

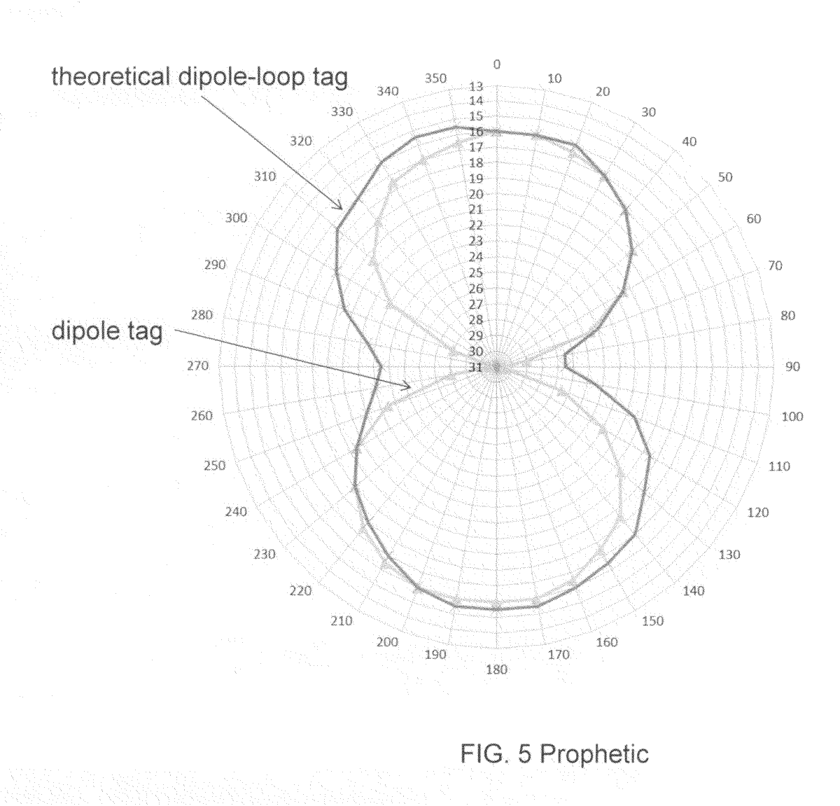

Referring to FIG. 5, the prophetic performance difference between a single dipole antenna and a theoretical dipole-loop antenna of the invention is illustrated. The single dipole antenna, which is labeled as “dipole antenna”, has limited uses resulting from inherent null locations. As seen in FIG. 5, the theoretical antenna of the invention, labeled as “dipole-loop antenna”, shows significant performance improvement along the null locations of the single dipole antenna. In limited space applications, where the use of a two dipole antenna system is prohibitive, the use of the dipole-loop antenna of the invention provides significant advantages in the communication to and from the tag.

As described above, the unique antenna geometry of an inwardly spiral pattern may be useful for RFID applications when connected to an RFID chip. The unique antenna geometry shown in FIG. 4, and other like configurations, however, may also be useful for sensing systems, such an EAS system. In one embodiment, for example, RFID chip 208 may be replaced with a diode or other non-linear passive device where the voltage and current characteristics are non-linear. The antenna for the diode or other passive non-linear EAS device may have the similar geometry as shown in FIG. 4, and may be trimmed to tune the antenna to the operating frequency band of the transmitter used to transmit interrogation signals for the EAS system. Similar to RFID system 100, the range of operating frequencies may vary, although the embodiments may be particularly useful for UHF spectrum, such as from 865 to 956 MHz, for example. The embodiments are not limited in this context.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an ASIC, Programmable Logic Device (PLD) or digital signal processor (DSP), and so forth. In yet another example, an embodiment may be implemented by any combination of programmed general-purpose computer components and custom hardware components. The embodiments are not limited in this context.

While certain embodiments of the disclosure have been described herein, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

What is claimed is:

1. A tag for identification or security of a commercial product, comprising:
a substrate having a surface;
a non-linear device mounted on said surface;
an antenna system connected on said non-linear device, said antenna having a first antenna portion, a second antenna portion and a third antenna portion, said first, second and third antenna portions connected to said non-linear device; wherein the first and second antenna portions comprise a ½ dipole structure each, and the third antenna portion comprises a loop structure; further comprising a fourth antenna portion being a shorted connection to one of the three antenna portions; wherein the antenna is tuned to an operating frequency band by modifying the electrical length for one, two, or all three antenna portions.

2. The tag of claim 1, wherein said non-linear device includes a device selected from the group consisting of integrated circuit, diode, capacitor, inductor, and combinations thereof.

3. The tag of claim 1, wherein at least one of said first and second ½ dipole antenna having a configuration selected from the group consisting of irregular spiral shape, squiggle, rectangular, square, and circular, and combinations thereof.

4. The tag of claim 1, further comprising an inductive portion to connect the first and second dipole portions together for impedance match of the non-linear device.

5. The tag of claim 4, wherein said inductive portion comprises a slot inductive portion.

6. The tag of claim 1, wherein said operating frequency is within a range of from about 865 MHz to about 956 MHz.

7. The tag of claim 2, wherein said integrated circuit is a semiconductor integrated circuit having electronic logic circuits to receive, store and transmit information.

8. The tag of claim 2, wherein said integrated circuit is a radio-frequency identification chip.

9. The tag of claim 1, further comprising an adhesive and release liner to attach to an object.

10. The tag of claim 1, wherein said antenna has an operating frequency of from about 865 MHz to about 868 MHz.

11. The tag of claim 10, wherein said antenna has an operating frequency of from about 868 MHz

12. The tag of claim 1, wherein said antenna has an operating frequency of from about 902 MHz to about 928 MHz.

13. The tag of claim 1, wherein said antenna has an operating frequency of about 915 MHz

14. The tag of claim 1, wherein said antenna has an operating frequency of from about 948 MHz to about 956 MHz.

15. The tag of claim 1, wherein said antenna has an operating frequency of from about 950 MHz.

16. The tag of claim 1, wherein said antenna has an operating frequency of from about 865 MHz to about 868 MHz, about 902 MHz to about 928 MHz, about 948 MHz to about 956 MHz, and combinations thereof.

17. A security system comprising a reader and the tag of claim 1.

18. A method for monitoring the status of commercial articles, comprising the steps of: placing the security system of claim 17 into a commercial location; associating the tag to a commercial article; and monitoring the location of the commercial article through the tag with the reader during transit of the commercial article out of the commercial location.
